(19) United States
(12) Patent Application Publication
(10) Pub. No.: US 2009/0230060 A1
(43) Pub. Date: Sep. 17, 2009

(54) PISTON POSITION DETECTION FOR PREPARATIVE CHROMATOGRAPHY COLUMN

(75) Inventors: Mark A. Snyder, Oakland, CA (US); Ken Baker, Martinez, CA (US); Christopher Moran, Petaluma, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., Hercules, CA (US)

(21) Appl. No.: 12/349,129

(22) Filed: Jan. 6, 2009

Related U.S. Application Data
(60) Provisional application No. 61/019,479, filed on Jan. 7, 2008.
(60) Provisional application No. 61/083,261, filed on Jul. 24, 2008.

(51) Int. Cl. B01D 15/08

(52) U.S. Cl. 210/656; 210/143

(57) ABSTRACT

In an axial-flow cylindrical preparative chromatography column that utilizes a piston to close off the top of the resin space inside the column and thereby eliminate void spaces at the top of the resin, one or more proximity detectors are incorporated in the piston head to either generate a signal indicating the proximity of the piston had to the resin, or to collect a signal, such as a optical signal, emitted from the resin. The value of the signal or any change in the signal is compared to a threshold value to ascertain when the piston head is in proximity to the resin so that the motion of the piston toward the resin can be halted before contact pressure from the piston head damages the resin.

### CROSS-REFERENCE TO RELATED APPLICATION

This application claims the benefit of U.S. Provisional Patent Application No. 61/019,479, filed Jan. 7, 2008, and of U.S. Provisional Patent Application No. 61/083,261, filed Jul. 24, 2008, and the contents of both such provisional applications are incorporated herein by reference in their entirety.

### BACKGROUND OF THE INVENTION

Preparative chromatography is a separation technique used to extract individual chemical species from mixtures of species. Preparative chromatography thus differs from analytical chromatography whose purpose is to detect the presence, concentration, or both of particular components in the mixture, or to determine the composition of the entire mixture. Preparative chromatography is commonly performed by passing a mobile phase, consisting of the source mixture dissolved in a liquid carrier, in an axial direction through a column packed with a solid resin as the stationary phase. The types of interaction between the mobile and stationary phases that result in the separation of the desired species from the source mixture can vary widely, and include such diverse methodologies as ion-exchange chromatography, affinity chromatography, and liquid-liquid or partition chromatography.

The depth of an axial preparative chromatography column must be limited to avoid an excessive pressure drop through the column, which would require a high mobile phase pump pressure, high power to drive the pump, or both. On the other hand, to produce the separated species at a rate that is commercially useful, a column of relatively large diameter compared to analytical columns is favored. The typical preparative column is thus at least several centimeters in diameter, and in some cases, columns with diameters of a meter or more are used. Columns of large diameters suffer certain drawbacks, however, notably a lack of effective flow distribution across the width of the column which results in a loss in separation or resolving power. Flow distributors are typically used at both ends of the column to overcome this problem. In some cases as well, particularly in columns that are arranged vertically with downward flow, the solid phase is packed in the column in a manner that eliminates or minimizes void spaces at the inlet side of the packing. This can be achieved by applying pressure to the packing, but the pressure can lead to fracture or pulverization of a portion of the packing material, particularly if the material is incompressible or fragile. The pressure can be controlled by use a sliding piston, also referred to as an adaptor, that is positioned above the resin and is lowered until it contacts the resin. The typical piston also contains flow distribution channels to help distribute the mobile phase across the column width. The lowering of the piston must be closely controlled, however, since excessive force can either compress the resin excessively, which will result in flow properties that are less than optimal, or, in the case of incompressible resins such as ceramic hydroxyapatite and controlled-pore glass, cause damage by fracturing the resin particles, resulting in poor liquid flow and degraded performance. Additionally, for those resins where packing is controlled by compressing the resin by a set percentage relative to the uncompressed state, the total amount of resin in the column prior to compression must be known.

### SUMMARY OF THE INVENTION

The present invention addresses the need for improved control of piston movement in a preparative chromatography column by incorporating one or more proximity detectors in the piston head and particularly in the surface of the piston head that faces the resin. Examples of proximity detectors are optical detectors such as fiber optics and electronic or electromagnetic detectors such as differential variable reluctance transformers (DVRTs). In the case of a fiber optic, an optical signal is transmitted through the fiber optic and out the end that is exposed in the piston head, and an optical signal reflected from the resin in the column is allowed to re-enter the fiber optic and travel back through the optic in the opposite direction. The intensity of the reflected optical signal returning through the fiber optic is monitored as a measure of the proximity of the exposed end and hence the piston head to the resin. When the proximity detector is a DVRT, the DVRT is either a contact or a non-contact DVRT, with non-contact DVRTs preferred. In either type of DVRT, sensing and reference coils are driven by a high-frequency sine-wave excitation, and a change in reluctance in the sensing coil, as measured by use of a sensitive demodulator, occurs as the DVRT approaches the resin. Regardless of whether a fiber optic or a DVRT is used, the emitted signal that indicates the proximity of the detector to the resin is fed to a controller in which the absolute intensity of the signal, the rate of change of the intensity, or both, or any other parameter of the optical or electronic signal that changes as the piston head approaches the resin, is compared to a set value or threshold. The controller then controls the movement of the piston accordingly, halting the movement once the threshold is reached.

### BRIEF DESCRIPTION OF THE DRAWINGS

FIG. 1 is a cross section of a screw with an embedded optical fiber for use in preparative chromatography columns of the present invention.

FIG. 2 is a cross section of a screw with an embedded DVRT for use in preparative chromatography columns of the present invention.

FIG. 3 is a diagram of a preparative chromatography column and system in accordance with the present invention.

### DETAILED DESCRIPTION OF THE INVENTION AND PREFERRED EMBODIMENTS

In embodiments of the invention utilizing fiber optics as the proximity detectors, conventional optical fibers that are readily available from commercial suppliers can be used. The size of each fiber can vary according to the needs and preferences of the user or manufacturer of the chromatography column. Convenient sizes in most cases will be within the range of from about 1 mm to about 3 mm in outer diameter. The benefits of this invention can be achieved with a single optical fiber, but two or more, such as two to twelve, and in many cases three or more, such as three to twelve, evenly distributed across the piston surface, can also be used for greater control. The use of multiple fiber optics can allow the controller to eliminate the effects of nonrepresentative or aberrational signals from individual fibers or to calculate an average of the reflected signals from different sites on the piston surface to be taken. In certain embodiments of the invention, the incident and reflected light will both be transmitted through the same optical fiber(s). In other embodiments, separate optical fibers will be used, one for incident light and another for reflected light. Alternatively, the optical fibers can be arranged in bundles that include both fibers transmitting incident light to the piston surface and fibers transmitting reflected light back to the detector and controller. A plurality of fiber bundles can be used, distributed across the piston surface. The terms “fiber optic means” and “optical fiber means” are used generically herein to denote individual fibers, fiber bundles, and two or more fibers or fiber bundles distributed across the piston surfaces.

The signal transmitted through the optical fibers is preferably a light signal, and can be generated at the input end of the fiber(s) by a conventional light source, such as a light emitting diode, a halogen lamp, or a laser. The reflected light can be received and detected by a conventional detector, such as for example a photodiode. Upon receipt of the reflected light, the photodiode emits an electrical signal whose voltage or current can be passed through an operational amplifier and fed to the controller. The controller can be a unit that is custom-made for the specific needs of the system, or a standard industrial control module such as those that are readily available from commercial suppliers. The controller can be programmed to compare the level of the electrical signal from the detector, i.e., either its voltage or its amperage, with a reference or baseline, and the difference compared to a threshold value. The reference or baseline can for example be taken when the piston is at its starting position.

In embodiments of the invention utilizing differential variable reluctance transformers (DVRTs) as the proximity detectors, conventional DVRTs that are available from commercial suppliers can be used. One such supplier is MicroStrain, Inc. of Burlington Vt., USA. The structures of DVRTs and the fundamentals of their operation are known in the art. DVRTs are half-bridge LVDTs (linear variable differential transformers), and among the various types of DVRTs are free-sliding DVRTs, gauging DVRTs, and non-contact DVRTs. Free-sliding and gauging DVRTs contain movable rods that contact the resin, while non-contact DVRTs are appropriate for resins that have high electrical conductivity.

The optimal proximity of the piston head to the resin, i.e., the position at which the movement of the piston is halted, can also vary at the choice of the operator or the column manufacturer or with the particular solid phase used in the column. In most cases, it is contemplated that piston movement will be halted when the piston is within about 1 mm, and preferably about 0.5 mm of the resin. For a resin that is to be compressed by the piston after the resin is placed in the column, the proximity detector can be used to determine the resin volume prior to compression, and compression can then be applied to reach a desired compression factor.

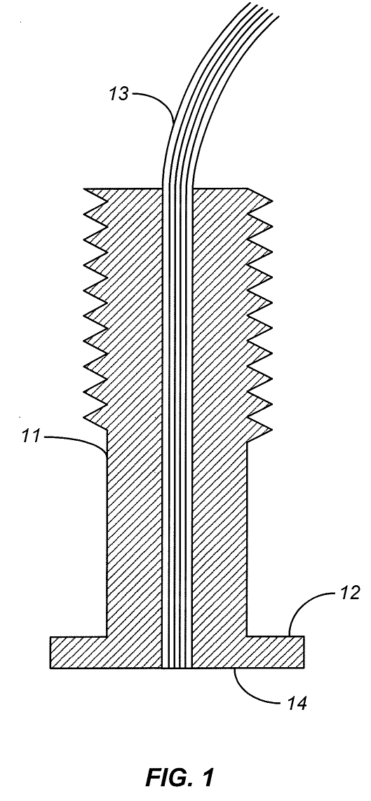

When an optical fiber proximity detector is used, the fiber can be mounted to the piston in any conventional manner and orientation that will allow light passing through the fiber to strike the surface of the resin and reflect back through the same or another fiber. The typical piston head has a flat surface facing the resin space, and certain pistons have a frit attached to the flat surface to serve as a flow distributor. In these cases, an optical fiber can be embedded in a bolt or screw of other fastening device by which the frit is secured to the piston. An example of a screw with an embedded optical fiber bundle is shown in FIG. 1. The frit-retaining screw 11 is shown in this figure in the orientation that it will assume when joining the frit to the piston head, with the head 12 of the screw at the bottom. The optical fiber bundle 13 is shown, passing axially through the screw and terminating at the surface 14 of the screw head that will be approximately flush with the surface of the frit that faces the resin space (which is below the piston in the view shown in the Figure).

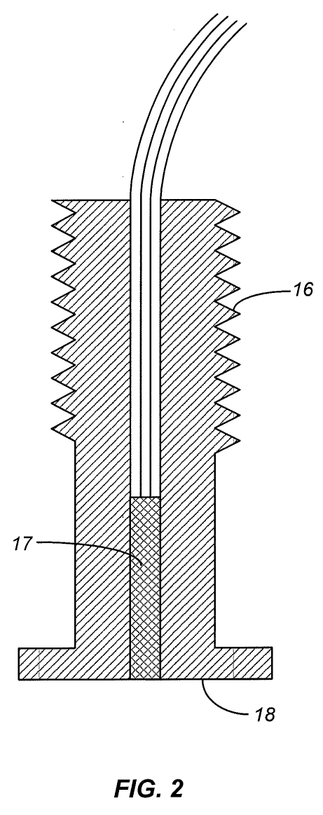

An example of a frit-retaining screw with an embedded DVRT is shown in FIG. 2. The screw 16 in this example is otherwise identical to the screw 11 of FIG. 1, and the DVRT 17 is exposed to the surface 18 of the screw head that will likewise be approximately flush with the surface of the frit.

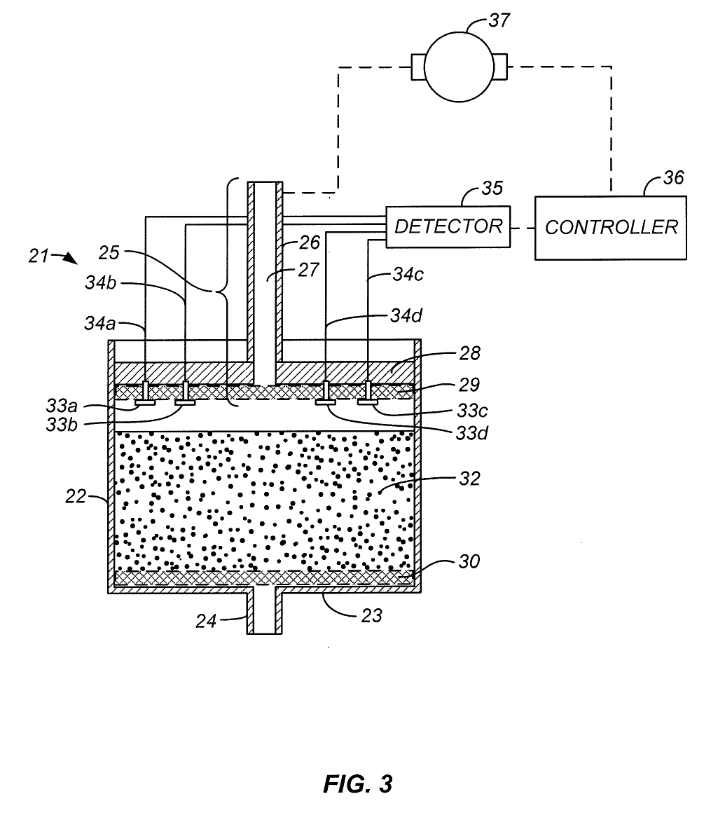

FIG. 3 depicts the entire chromatography column 21 including the cylindrical tube 22 and base 23 with fluid outlet tubing 24 at the base and a piston 25 at the upper end. The piston 25 includes a piston shaft 26, which is hollow to accommodate an axial conduit 27 through which the liquid source mixture enters the column, and a piston head 28 which can be sealed against the inner walls of the cylindrical tube 22 (typically by an inflatable seal) but is capable of being moved vertically along the axis of the shaft 26. Resin retention and flow distribution across the width of the column are achieved by an upper frit 29 secured to the underside of the piston head and a lower frit 30 resting on the cylinder floor, and the resin 32 resides between the two frits. A series of retaining screws 33a, 33b, 33c, 33d secure the upper frit 29 to the piston head 28, with proximity detectors 34a, 34b, 34c, 34d, which can be either optical fibers or DVRTs, embedded in the screws. The proximity detectors 34a, 34b, 34c, 34d are joined to a detector 35 containing sensor electronics. A controller 36 receives the signal emitted by the detector, and sends an instruction signal to a piston drive 37 which drives the piston. Any conventional motor capable of driving a piston at a slow rate can be used. One example is a stepper motor and another is a servomotor; still other examples will be readily apparent to those skilled in the art.

In the claims appended hereto, the term “a” or “an” is intended to mean “one or more.” The term “comprise” and variations thereof such as “comprises” and “comprising,” when preceding the recitation of a step or an element, are intended to mean that the addition of further steps or elements is optional and not excluded. All patents, patent applications, and published reference materials in general that are cited in this specification or added thereto subsequent to filing are incorporated herein by reference in their entirety. Any discrepancy between any reference material cited herein and an explicit teaching of this specification is intended to be resolved in favor of the teaching in this specification. This includes any discrepancy between an art-understood definition of a word or phrase and a definition explicitly provided in this specification of the same word or phrase.

We claim:

1. In a preparative chromatography column comprising a cylindrical tube, a piston head movably retained within said tube to define an upper extremity of a resin space in said tube, and drive means to move the piston head within said tube, the improvement comprising:
a proximity detector that is secured to said piston head and exposed to said resin space and that emits a signal when said piston head is within a preselected distance of resin in said resin space, and
a controller in signal communication with said proximity detector to receive said signal and to direct said drive means.

2. The preparative chromatography column of claim 1 wherein said proximity detector comprises an optical fiber conveying light into said resin space and said signal is reflected light from said resin conveyed back through said optical fiber.

3. The preparative chromatography column of claim 1 wherein said proximity detector comprises a bundle of optical fibers conveying light into said resin space and said signal is reflected light from said resin conveyed back through said bundle.

4. The preparative chromatography column of claim 1 wherein said proximity detector comprises a differential variable reluctance transformer and said signal is a reluctance signal.

5. The preparative chromatography column of claim 1 wherein said piston head has a flat surface facing said resin space, and said preparative chromatography column comprises a plurality of said proximity detectors spaced apart along said flat surface, each said proximity detector emitting a signal when said proximity detector is within a preselected distance of resin in said resin space.

6. The preparative chromatography column of claim 1 wherein said preselected distance is about 1 mm.

7. The preparative chromatography column of claim 1 wherein said preselected distance is about 0.5 mm.

8. The preparative chromatography column of claim 1 wherein said piston head has a flat surface facing said resin space and a frit secured to said flat surface by a bolt, and said proximity detector is embedded in said bolt.

9. A method for lowering a piston head over a resin space in a preparative chromatography column to within a preselected distance of a resin retained in said resin space, said method comprising:
with a proximity detector secured to said piston head and exposed to said resin space, detecting a signal generated by said proximity detector that is indicative of the proximity of said piston head to said resin; and
converting said signal to an instruction to a drive means governing movement of said piston head to halt said movement when said piston head is within said preselected distance of said resin.

10. The method of claim 9 wherein said proximity detector comprises optical fiber means and said method further comprises passing incident light through said optical fiber means into said resin space and detecting as said signal any reflected light from said resin entering said optical fiber means.

11. The method of claim 9 wherein said proximity detector comprises a differential variable reluctance transformer, and said method comprises converting a change in reluctance generated by said differential variable reluctance transformer to said instruction.

12. The method of claim 9 wherein said piston head has a flat surface facing said resin space and a plurality of said proximity detectors spaced apart along said flat surface, and said method comprises converting signals from all of said proximity detectors collectively to said instruction.
